(19) United States
(12) Patent Application Publication
(10) Pub. No.: US 2025/0247431 A1
(43) Pub. Date: Jul. 31, 2025

(54) CONTEXT-BASED POLICY MAPPING FOR SECURITY COMPLIANCE

(71) Applicant: Palo Alto Networks, Inc., Santa Clara, CA (US)

(72) Inventors: Li Peng, Monte Sereno, CA (US); Nehal Bipinbhai Naik, Cupertino, CA (US); Xun Zhou, Cupertino, CA (US); Hoang Hoa Le, Santa Clara, CA (US)

(21) Appl. No.: 18/425,625

(22) Filed: Jan. 29, 2024

(51) Int. Cl. H04L 9/40

(52) U.S. Cl. CPC H04L 63/20

(57) ABSTRACT

A policy mapping module maintains and distributes policy maps indicating recommended security categories/category attributes for endpoint devices managed by a server device. Based on detecting a login event at an endpoint device, the policy mapping module communicates parameters of the updated policy map to the server device. The server device communicates the policy map to the endpoint device that deploys the policy map on a corresponding probing agent. The probing agent communicates reports of changes to categories/category attributes from the policy map to the server device, and the server device enforces its security policy based on evaluating the changes against security policies at the server device.

### BACKGROUND

The disclosure generally relates to electronic communication techniques (e.g., CPC class H04) and arrangements for maintenance, administration, or management of packet switching networks (e.g., CPC subclass H04L 41/00).

Devices that monitor network traffic across an organization have defined security policies that specify allowed software, allowed source/destination Internet Protocol (IP) addresses and ports for traffic routing, allowed protocols, allowed types/categories of applications and associated risks, etc. On a broader scale, these security policies can be applied to different security settings such as security categories and attributes of security categories that should be enabled at endpoint devices. These security settings vary by device context depending on security privileges of endpoint devices, whether endpoint devices are communicating across internal or external networks, architecture of networks where endpoint devices are communicating, etc. Ensuring compliance of endpoint devices with security settings prevents cybersecurity incidents for these various device contexts.

### BRIEF DESCRIPTION OF THE DRAWINGS

Embodiments of the disclosure may be better understood by referencing the accompanying drawings.

FIG. 1 is a schematic diagram of an example system for enforcing security compliance at endpoint devices with context-based policy maps.

FIG. 2 is a protocol sequence diagram of a client/server protocol for deploying policy maps at an endpoint device using security policies at a server device and policy mappings.

FIG. 3 depicts an example computer system with a policy mapping module that distributes policy maps for ensuring security compliance of server and endpoint devices.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Real-time verification of security compliance of devices across an organization poses a logistical challenge due to devices deployed in multiple security contexts and managed by different servers having different security policies thereon. Moreover, different security contexts can correspond to different recommended security categories/category attributes to enable within each context. The present disclosure proposes a framework/protocol wherein agents are deployed on devices that probe each device for status of security settings and report the status to servers managing those devices. Based on a login or other instantiation of an endpoint device a server retrieves a policy map from a policy mapping module and pushes the policy map to an agent on the endpoint device to ensure security compliance.

Once the agent receives the policy map, the agent probes the endpoint device to track the changes of each category/category attribute indicated by the policy map. To exemplify, for a firewall category, the agent tracks firewall versions, manufacturers, and metadata for firewalls enabled at the device. The agent probes events at the device (e.g., events indicating software installation, configuration changes, etc.), for instance through a security event log for a Windows® Security Center instance, to track changes of each category/category attribute. Across probing time periods, the agent maintains cached reports storing the tracked statuses. If the agent times out during a probing time period due to incomplete probing of the category/category attributes indicated in the policy map, the agent communicates the most recent cached report to the server. Otherwise, the agent communicates a real-time report to the server. In response to receiving a real-time or cached report, the server compares changes of each category/category attribute indicated in the report with its security policy to identify any deviations in behavior from the security policy at the device and enforce the security policy based on the deviations. Probing at the scope of each device using context-based policy maps allows for real-time detection of security policy deviations across an organization at a granular scale. Additionally, the context-based policy maps can be updated in response to newly identified vulnerabilities and flaws within various contexts, allowing for more up-to-date detection of these new identified vulnerabilities and flaws.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The term “policy map” as used herein refers to any data structure indicating security settings such as security categories and category attributes (e.g., software/application/device versions and manufacturers, configuration settings, etc.). The data structure can comprise a compact data structure such as a bitmap, and devices receiving the bitmap can be configured with a mapping between bits in the bitmap and corresponding security categories/attributes.

The terms “compliance” and “security compliance” both refer to adherence of security policies with a global configuration of security policies as defined by policy maps for differing security contexts.

The term “device” can refer to a physical device or a virtual device.

The term “context” in reference to a server device and endpoint device refers to a security context where the server device and endpoint device are deployed such as security privileges for networks connected to the server device and endpoint device, security zones for the server device and endpoint device, etc.

### Example Illustrations

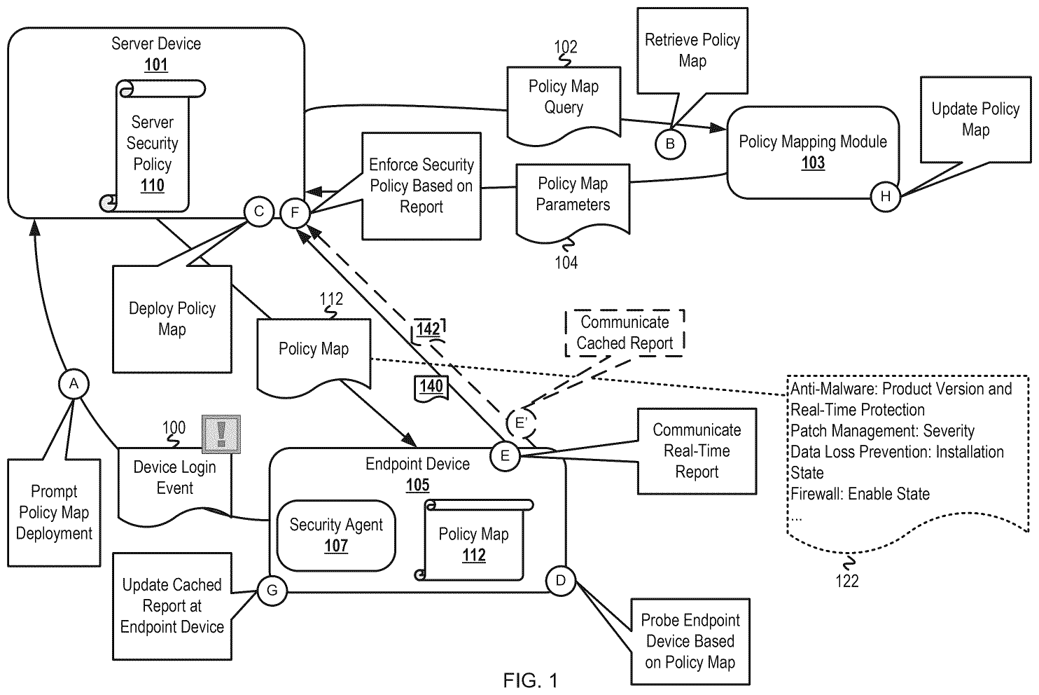

FIG. 1 is a schematic diagram of an example system for enforcing security compliance at endpoint devices with context-based policy maps. A server device 101 and an endpoint device 105 operate in tandem to ensure deployment of a policy map 112 at the endpoint device 105 based on policy maps stored at a policy mapping module 103. The server device 101 compares reports generated from probing the endpoint device 105 with a security agent 107 according to the policy map 112 with a server security policy 110 to identify deviations in behavior of the endpoint device 105 at the server device 101 that indicate lack of security compliance.

FIG. 1 is annotated with a series of letters A, B, C, D, E, E′, F, G, and H. Each stage represents one or more operations. The depicted stages represent operations for a time period of probing at the endpoint device 105. Stage E occurs if the probing completes during the time period, while stage E′ occurs if the probing times out during the time period. Although these stages are ordered for this example, the stages illustrate one example to aid in understanding this disclosure and should not be used to limit the claims. Subject matter falling within the scope of the claims can vary from what is illustrated.

At stage A, a device login event 100 occurs at the endpoint device 105 and the security agent 107 communicates indications of the device login event 100 to the server device 101. The event 100 can indicate a login, session initiation with the server device 101, powerup, etc. at the endpoint device 105. Although the event 100 is depicted as being detected by the security agent 107 at the endpoint device 105, alternatively the server device 101 can detect that the endpoint device 105 has been instantiated, for instance based on initiations of flows/sessions with the server device 101.

At stage B, the server device 101 communicates a policy map query 102 to the policy mapping module 103 for retrieval of a policy map based on the server/endpoint context and the policy mapping module 103 returns policy map parameters 104 corresponding to a policy map for the endpoint device 105. In some embodiments, the policy mapping module 103 can store a single policy map for devices managed by the server device 101, whereas for other embodiments the policy mapping module 103 can stored multiple policy maps when managed devices have varying contexts. The policy map parameters 104 comprise security categories/category attributes to track at the endpoint device 105. Each category indicates a cybersecurity category for associated security settings/applications/services such as “firewall” or “data loss prevention (DLP),” and attributes indicate manufacturers, versions, identifiers, and other characteristics of security settings/software/services/devices for each category.

At stage C, the server device 101 generates and deploys a policy map 112 to the endpoint device 105. The policy map 112 can comprise a different data structure than a data structure storing the policy map parameters 104, for instance a bitmap or other short format data structure for efficient policy map distribution. An example policy map 122 comprises the category anti-malware with attributes product version and real-time protection, the category patch management with attribute severity, the category data loss prevention with attribute installation state, and the category firewall with attribute enable state.

At stage D, the security agent 107 configures the policy map 112 for probing. The security agent 107 probes the endpoint device 105 for changes to categories/category attributes indicated by the policy map 112. To exemplify, the security agent 107 can monitor event logs from a Windows Security Center instance to identify instantiation or termination of processes related to the policy map 112. If an event log indicates that a security setting/service/application corresponding to one of the categories/category attributes is installed or terminated/disabled, the probing by the security agent 107 can indicate this in a log to include in a report to the server device 101. Probing by the security agent 107 occurs as a task manager, monitoring active processes and tracking metadata associated with those processes that relate to the policy map 112.

Probing by the security agent 107 occurs continuously according to a schedule of time periods. If, within a time period, the security agent 107 probes all categories/category attributes indicated by the policy map 112, then at stage E the security agent 107 generates a real-time report 140 indicating status of each of the categories/category attributes to communicate the server device 101 or other cybersecurity device for security policy enforcement. Otherwise, if the security agent 107 times out probing within a time period, at stage E′ the security agent 107 communicates a cached report 142 to the server device 101 or other cybersecurity device from a most recent time period.

At stage F, the server device 101 inspects the real-time report 140 or the cached report 142 against the server security policy 110 to determine security policy enforcement to perform based on deviations in behavior of the endpoint device 105 from security compliance. The server security policy 110 can indicate security services/software/settings to enable for categories/category attributes in the policy map 112, and deviations can comprise any such services/software/settings that are not correctly enabled as indicated by the real-time report 140 or the cached report 142. Security policy enforcement can vary with respect to severity of incorrectly configured security settings, security privileges of the endpoint device 105 and/or a security zone where the server device 101 and the endpoint device 105 are deployed, etc. For instance, for low-severity infractions, the server device 101 can generate an alert for the endpoint device 105 to enable certain security settings, whereas for high-severity infractions the server device 101 can communicate indications restricted access of the endpoint device 105 to certain applications/services to the security agent 107 and notify an administrator, and the security agent 107 can subsequently enforce the server security policy 110. At stage G, the security agent 107 updates a cached report stored on the endpoint device 105 based on results of the probing at the most recent time period.

At stage H, an administrator or system managing policy maps for an organization updates the policy map for the endpoint device 105. Policy maps stored at the policy mapping module 103 can be maintained centrally across an organization and the server security policy 110 can be maintained based on organization-wide security policies. A system or administrator (not depicted) can distribute security policies such as the server security policy 110 based on policies for each server or server context being updated, for instance as new flaws/vulnerabilities are identified and recommended security categories/category attributes are modified for corresponding security contexts. Policy maps can be updated in real-time at the endpoint device 105 according to the foregoing operations. While the policy mapping module 103 is depicted as a separate component from the server device 101 in FIG. 1, the policy mapping module 103 can be running on the server device 101.

In some embodiments, when a previous policy map is still configured on the security agent 107, the security agent 107 can immediately begin probing in response to the device login event 100 using the previous policy map before updating with the policy map 112 for additional probing.

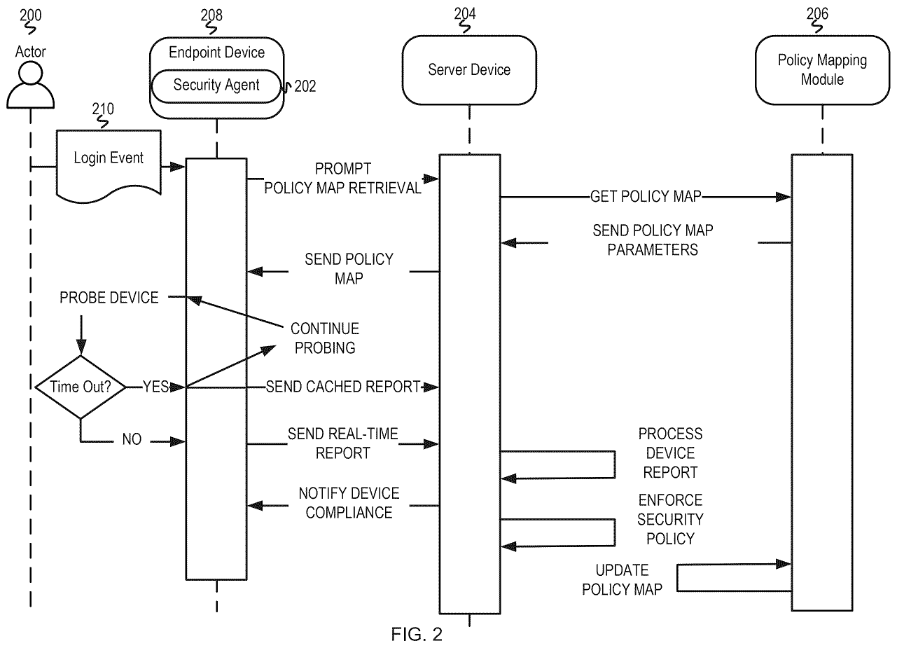

FIG. 2 is a protocol sequence diagram of an example client/server protocol for deploying policy maps at an endpoint device using security policies at a server device and policy mappings. The example operations are described with reference to an endpoint device, a server device, and a policy mapping module for consistency with the earlier figure and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

The operations in FIG. 2 are prompted by a login event 210 triggered by an actor 200 detected by a security agent 202 at an endpoint device 208 (e.g., a user), for instance the actor logging into or powering up the endpoint device 208, connecting to the Internet via a server device 204, etc. Based on the login event 210, the security agent 202 communicates a prompt to the server device 204 for a policy map. Based on receiving the prompt from the security agent 202, the server device 204 communicates a query to a policy mapping module 206 for a most recent policy map corresponding to the endpoint device 208. The query can indicate an identifier of the endpoint device 208. The policy mapping module 206 sends policy map parameters in response indicating categories and category attributes for the policy map of the endpoint device 208. Although depicted as a separate component, the policy mapping module 206 can be a module running on the server device 204.

The server device 204 sends a policy map generated from the retrieved parameters to the security agent 202. For instance, the policy map can be stored at the endpoint device 208 as a bitmap or other short format data structure and the server device 204 can encode the policy map parameters into a bitmap.

The security agent 202 receives and deploys the policy map. The security agent 202 probes event data on the device (e.g., event data for running processes) during a time period and collects/logs event data for changes in categories/category attributes indicated by the policy map. If, during the time period, the security agent 202 collects data for all of the categories/category attributes in the policy map, the security agent 202 sends a real-time report indicating probed data during the time period to the server device 204. Otherwise, if the security agent 202 times out during probing for the time period, the security agent 202 sends a cached report from a most recent previous time period to the server device 204 and continues probing based on the policy map at a subsequent time period.

Based on receiving a cached report or real-time report from the security agent 202, the server device 204 processes the device report to generate a notification of device compliance to the security agent 202 and, if any deviations in behavior of the endpoint device 208 are identified, enforce the security policy stored at the server device 204 to ensure security compliance. The notification of device compliance indicates each category/category attribute in the policy map at the endpoint and whether, according to the report, they were correctly configured on the endpoint device 208. The device compliance notification can be accessible through a user interface at the endpoint device 208. Any security policy enforcement can depend on severity of deviations in behavior at the endpoint device 208. For high-severity deviations (e.g., when the endpoint device 208 may be compromised by malicious actors), the server device 204 can communicate indications of restricted access for the endpoint device 208 to the security agent 202. For low-severity deviations (e.g., when security settings may have been accidentally disabled at the endpoint device 208), the server device 204 can instead generate a user alert to enable security categories/category attributes that were incorrectly configured according to the device report.

Policy maps including the policy map for the endpoint device 208 are periodically updated at the policy mapping module 206. For instance, the policy maps can be updated by a cybersecurity administrator or other system as new flaws vulnerabilities are identified for a context of the endpoint device 208 and the server device 204. The policy maps can be updated to include categories and category attributes for the identified flaws/vulnerabilities.

### Variations

Operations for maintaining and deploying policy maps are described herein in reference to devices in a client/server architecture. These devices can comprise any device (“server device” above) managing cybersecurity for client devices (“endpoint device” above). Any modifiers of the term “device” are not to be construed as limiting as to the particular configuration and/or network architecture of and across devices.

The protocol sequence diagram is provided to aid in understanding the illustrations and are not to be used to limit scope of the claims. The protocol sequence diagram depicts example operations that can vary within the scope of the claims. Additional operations may be performed; fewer operations may be performed; the operations may be performed in parallel; and the operations may be performed in a different order. For example, the operations for deploying a policy map at an endpoint device and probing the endpoint device with the policy map based on a login event in FIG. 2 can occur asynchronously with updating the policy map as new flaws and vulnerabilities are identified. It will be understood that each block of the protocol sequence diagram corresponding to an arrow, and combinations of blocks in the protocol sequence diagram, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the protocol sequence diagram.

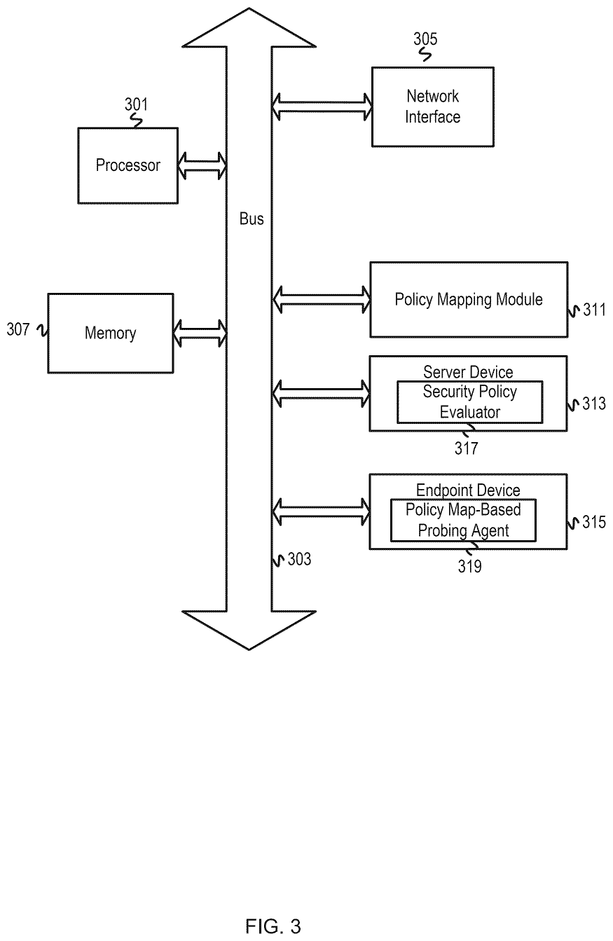

FIG. 3 depicts an example computer system with a policy mapping module that distributes policy maps for ensuring security compliance of server and endpoint devices. The computer system includes a processor 301 (possibly including multiple processors, multiple cores, multiple nodes, and/or implementing multi-threading, etc.). The computer system includes memory 307. The memory 307 may be system memory or any one or more of the above already described possible realizations of machine-readable media. The computer system also includes a bus 303 and a network interface 305. The system also includes a policy mapping module 311, a server device 313 comprising a security policy evaluator 317, and an endpoint device 315 comprising a policy map-based probing agent (agent) 319. The policy mapping module 311 generates and deploys policy maps that indicate security categories and category attributes to ensure security compliance across an organization. The server device 313 receives parameters for policy maps from the policy mapping module 311 and generates policy maps to communicate to the endpoint device 315. Based on receiving the generated policy maps, the endpoint device 315 deploys the policy maps on the agent 319 to probe for changes to security categories/category attributes within time periods. If the agent 319 completes probing of the categories/category attributes within a time period, the agent 319 communicates a real-time report of the probing to the server device 313. Otherwise, the agent 319 communicates a cached report from probing a previous time period to the server device 313. The server device 313 then evaluates the device report with the security policy evaluator 317 to identify and correct any security misconfigurations on the endpoint device 315 to ensure security compliance. Any one of the previously described functionalities may be partially (or entirely) implemented in hardware and/or on the processor 301. For example, the functionality may be implemented with an application specific integrated circuit, in logic implemented in the processor 301, in a co-processor on a peripheral device or card, etc. Further, realizations may include fewer or additional components not illustrated in FIG. 3 (e.g., video cards, audio cards, additional network interfaces, peripheral devices, etc.). The processor 301 and the network interface 305 are coupled to the bus 303. Although illustrated as being coupled to the bus 303, the memory 307 may be coupled to the processor 301.

1. A method comprising:
at a first device,
identifying at least one of categories and category attributes of security compliance for a context of the first device;
generating a policy map indicating the at least one of categories and category attribute; and
based on detecting login events at one or more devices communicatively coupled to the first device, communicating the policy map to the one or more devices; and
at each device of the one or more devices,
probing the device for data for the at least one of categories and category attributes indicated by the policy map; and
based on completion of the probing during a first time period, communicating a real-time report indicating results of the probing to the first device; and
at the first device,
identifying a deviation in behavior from a security policy for the first device based on the real-time report; and
performing security policy enforcement based on the identified deviation.

2. The method of claim 1, further comprising, based on timing out of the first time period, communicate a cached report indicating results of probing from a second time period prior to the first time period.

3. The method of claim 1, wherein identifying the at least one of categories and category attributes of security compliance for the context of the first device comprises identifying the at least one of categories and category attributes based, at least in part, on receiving, at the first device, indications of one or more changes to security compliance for the context of the first device.

4. The method of claim 1, wherein probing the device comprises probing event data logged on the device for changes of the at least one of categories and category attributes.

5. The method of claim 1, wherein the policy map indicates categories of cybersecurity software and system software and attributes of each category indicating a state of enablement and characteristics of the cybersecurity software and system software.

6. One or more non-transitory machine-readable media having program code stored thereon, the program code comprising instructions to:
identify at least one of categories and category attributes of security compliance for a context of the one or more non-transitory machine-readable media;
generate a policy map based indicating the at least one of categories and category attributes; and
for each medium of the one or more non-transitory machine-readable media,
based on detecting a login event at the medium, configure the policy map on the medium;
probe the medium for the at least one of categories and category attributes indicated by the policy map;
detect, from the probing, changes in the at least one of categories and category attributes at the medium; and
perform security policy enforcement at the medium based, at least in part, on a real-time report indicating the changes and a security policy for the one or more non-transitory machine-readable media.

7. The one or more non-transitory machine-readable media of claim 6, wherein the program code further comprises instructions to, based on determining that a first time period has elapsed since probing the medium, generate a cached report indicating changes in the at least one of categories and category attributes with the policy map during a second time period prior to the first time period.

8. The one or more non-transitory machine-readable media of claim 6, wherein the instructions to identify the at least one of categories and category attributes of security compliance for the context of the one or more non-transitory machine-readable media comprise instructions to identify the at least one of categories and category attributes based, at least in part, on indications of one or more changes to security compliance for the context of the one or more non-transitory machine-readable media.

9. The one or more non-transitory machine-readable media of claim 6, wherein the instructions to probe the medium for deviations in behavior from the policy map comprise instructions to probe event data logged on the medium for changes indicating deviations in behavior from the policy map.

10. The one or more non-transitory machine-readable media of claim 6, wherein the at least one of categories and category attributes of security compliance indicate at least one of manufacturers and product versions.

11. The one or more non-transitory machine-readable media of claim 6, wherein the policy map indicates categories of cybersecurity software and system software and attributes of each category indicating a state of enablement and characteristics of the cybersecurity software and system software.

12. A system comprising:
a first processor;
a first machine-readable medium having instructions stored thereon that are executable by the first processor to cause the system to,
identify at least one of categories and category attributes of security compliance for a context of the first machine-readable medium;
based on detecting a login event at a second machine-readable medium, generate a policy map indicating the at least one of categories and category attributes; and
communicate the policy map to the second machine-readable medium;
a second processor; and
the second machine-readable medium having instructions stored thereon that are executable by the second processor to cause the system to,
probe the second machine-readable medium for changes in the at least one of categories and category attributes from the policy map;
detect, from the probing, one or more changes in the at least one of categories and category attributes at the second machine-readable medium from the policy map; and
communicate a real-time report indicating the one or more changes to the first machine-readable medium for security policy enforcement.

13. The system of claim 12, wherein the second machine-readable medium further has stored thereon instructions executable by the second processor to cause the system to, based on determining that a first time period has elapsed since probing the second machine-readable medium, communicate, to the first machine-readable medium, a cached report indicating changes of the at least one of categories and category attributes at the second machine-readable medium during a second time period prior to the first time period.

14. The system of claim 12, wherein the instructions to identify the at least one of categories and category attributes of security compliance for the context of the first machine-readable medium comprise instructions executable by the first processor to cause the system to identify the at least one of categories and category attributes based, at least in part, on receiving, at the first machine-readable medium, indications of one or more changes to security compliance for the context of the first machine-readable medium.

15. The system of claim 14, wherein the at least one of categories and category attributes of security compliance indicate at least one of manufacturers and product versions.

16. The system of claim 12, wherein the instructions to probe the second machine-readable medium for deviations in behavior from the policy map comprise instructions executable by the second processor to cause the system to probe event data logged on the second machine-readable medium for changes indicating deviations in behavior from the policy map.

17. The system of claim 12, wherein the instructions to probe the second machine-readable medium for deviations in behavior from the policy map comprise instructions executable by the second processor to cause the system to probe the second machine-readable medium based on indications of a login by the second machine-readable medium.

18. The system of claim 12, the at least one of categories and category attributes of security compliance indicate at least one of manufacturers and product versions.

19. The system of claim 12, wherein the policy map indicates categories of cybersecurity software and system software and attributes of each category indicating a state of enablement and characteristics of the cybersecurity software and system software.

20. The system of claim 12, wherein the context of the first machine-readable medium comprises at least one of a source zone, a destination zone, a source Internet Protocol (IP) address, a destination IP address, a source device, and a destination device.
